(19) United States
(12) Patent Application Publication
(10) Pub. No.: US 2010/0242636 A1
(43) Pub. Date: Sep. 30, 2010

(54) DEVICE FOR FINAL CALIBRATION OF TAPERED TUBULAR SHAFTS

(75) Inventor: Nicola Di Tullio, Spinazzola (IT)

Correspondence Address: Leason Ellis LLP, 81 Main Street, Suite 503, White Plains, NY, 10601, US

(73) Assignee: Officine Meccaniche Murgesi S.R.L., Spinazzola (IT)

(21) Appl. No.: 12/598,174

(22) PCT Filed: Apr. 30, 2007
(86) PCT No.: PCT/IT07/00312

§ 371 Date: May 24, 2010

(51) Int. Cl. G01M 19/00

(52) U.S. Cl. 73/865.8

(57) ABSTRACT

A device for final calibration of tapered tubular shafts, wherein a number of pressure rollers are fitted to an annular support radially with respect to an axis of the annular support, are arranged about the axis to define a calibration passage for a tapered shaft, and are movable, with respect to the annular support and under control of a cam pressure device common to all the pressure rollers, in respective radial directions to vary the size of the passage alongside variations in the section of the tapered tubular shaft travelling through the passage.

### TECHNICAL FIELD

The present invention relates to a device for final calibration of tapered tubular shafts.

### BACKGROUND ART

Tapered tubular shafts are known, e.g. from U.S. Pat. No. 6,629,632, to be produced by gradually folding a trapezoidal metal sheet to position two opposite lateral edges of the sheet facing each other, and to form a tapered tubular shaft with an open longitudinal join line; feeding the longitudinally open shaft through a final calibration device, in which a number of pressure rollers, substantially equally spaced about the shaft, apply radially inward pressure on the shaft to press the two lateral edges defining the join line against each other; and welding the shaft along the join line while the two lateral edges are pressed against each other by the final calibration device.

In final calibration devices of the above type, the pressure rollers define a passage through which the tapered, longitudinally open shaft for welding is fed, and are movable radially to adapt the size of the passage to the size of the tapered shaft section currently being fed through the passage. For this purpose, the pressure rollers are connected to a radial thrust device which, in known final calibration devices, normally comprises, for each pressure roller, a respective hydraulic jack fixed, radially with respect to the axis of the passage, to an annular plate common to all the hydraulic jacks and coaxial with the passage axis.

Known radial thrust devices of the above type have several drawbacks, mainly due to the presence of the hydraulic jacks, the transverse dimensions of which seriously limit the number of pressure rollers that can be accommodated about the axis of the passage, and hence the final calibration precision of the tapered, longitudinally open shaft for welding, and the hydraulic control circuits of which make for a relatively complex design of the thrust device as a whole.

### DISCLOSURE OF INVENTION

It is an object of the present invention to provide a device for final calibration of tapered tubular shafts, in which the radial thrust device is cheap and easy to produce and, at the same time, eliminates the aforementioned drawbacks.

According to the present invention, there is provided a device for final calibration of tapered tubular shafts, as claimed in claim 1 and, preferably, in any one of the Claims depending directly or indirectly on claim 1.

### BRIEF DESCRIPTION OF THE DRAWINGS

A non-limiting embodiment of the present invention will be described by way of example with reference to the accompanying drawings, in which:

FIG. 1 shows a front view of a preferred embodiment of the final calibration device according to the present invention;

FIG. 2 shows a section along line II-II in FIG. 1;

FIG. 3 shows a larger-scale front view of a detail in FIG. 1;

FIGS. 4 and 5 show a detail of FIG. 3 in respective operating configurations.

### BEST MODE FOR CARRYING OUT THE INVENTION

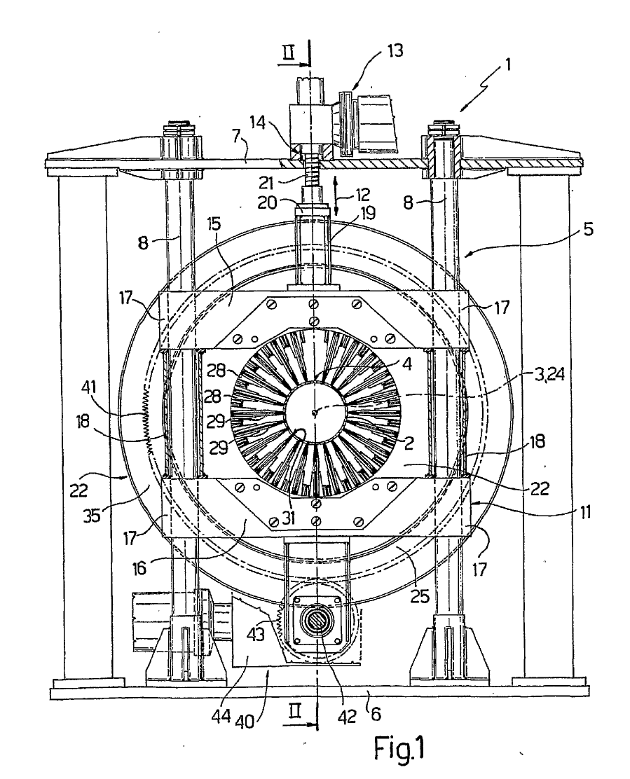

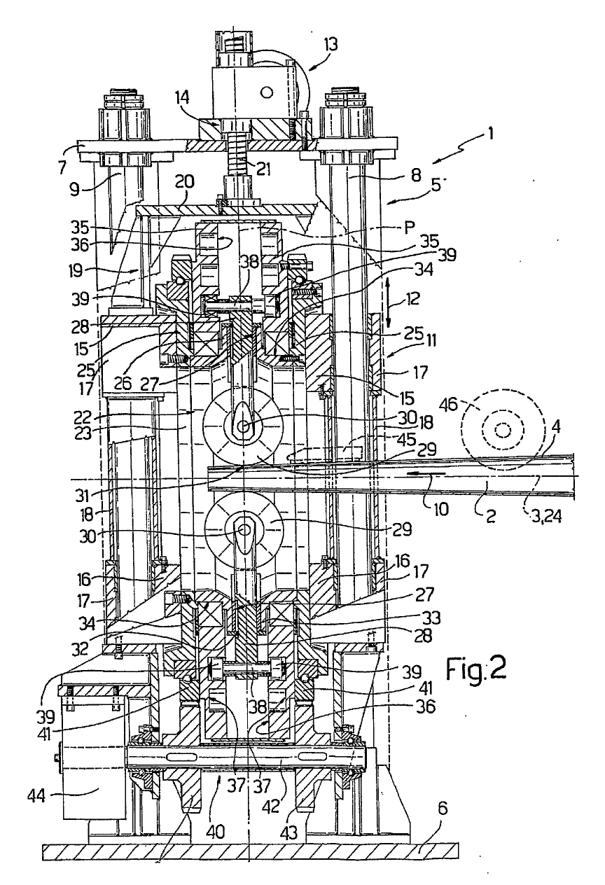

Number 1 in FIGS. 1 and 2 indicates as a whole a device for final calibration of a tapered tubular shaft 2 (FIG. 2) having an axis 3 and an open longitudinal join line 4.

Device 1 comprises a fixed frame 5 in the form of a rectangular parallelepiped and in turn comprising a base 6, an upper cross member 7 facing base 6, and two pairs of parallel columns 8 and 9 extending upwards from base 6 to connect upper cross member 7 to base 6. Each column 8 and a respective column 9 are located specularly side by side with respect to a vertical plane P crosswise to the FIG. 2 plane and to the feed direction 10 of shaft 2 through device 1.

Device 1 also comprises a carriage 11 mounted to run along columns 8 and 9, in a vertical direction 12 perpendicular to direction 10 and axis 3, under the control of an actuator assembly 13 fitted to upper cross member 7 and connected to carriage 11 by a screw-nut screw coupling 14. For each pair of columns 8, 9, carriage 11 comprises an upper cross member 15 and a lower cross member 16, each of which is horizontal, is parallel to plane P, and is fitted at each end with a bush 17 fitted in sliding manner to relative column 8, 9 and connected by a tubular spacer 18 to the bush 17 fitted to the same column 8, 9 and to the other cross member 16, 15. The two upper cross members 15 are connected to each other by a U-shaped bracket 19, a central plate 20 of which, extending through plane P, is fitted with the bottom end of screw 21 of coupling 14.

Carriage 11 supports a pressure device 22 movable with carriage 11 and comprising, as shown more clearly in FIG. 2, a hollow, substantially cylindrical drum 23, which is located inside the space defined by columns 8 and 9, has an axis 24 perpendicular to plane P and located centrally with respect to upper cross member 15 and lower cross member 16, and has two annular end flanges 25, each lying in a respective plane parallel to plane P, and each connected integrally to a respective upper cross member 15 and a respective lower cross member 16.

Drum 23 has a circumferential rib 26 projecting outwards from the outer surface of drum 23, and having a number of radial through holes 27, the axes of which lie in plane P. Holes 27 are substantially equally spaced about axis 24, and house, in axially sliding manner with the interposition of respective bushings, respective control rods 28 for controlling respective pressure rollers 29. More specifically, the end of each rod 28 facing axis 24 defines a respective fork which, by means of a respective pin 30 with its axis in plane P, supports for rotation relative pressure roller 29, which projects outwards of the relative fork and defines, with all the other pressure rollers 29, a circular passage 31 coaxial with axis 24.

To keep pressure rollers 29 perpendicular to plane P and in a radial position with respect to axis 24 at all times, each rod 28 has a longitudinal lateral groove, which is engaged in sliding manner by a key 32 defined by an inner tooth of a relative ring 33 fixed to rib 26 at the outer end of relative hole 27.

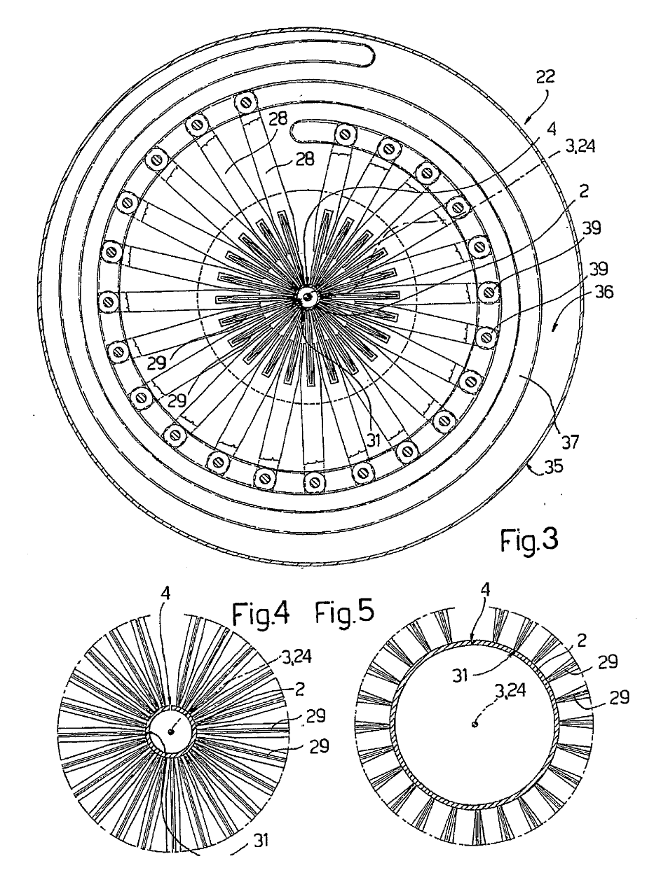

With each flange 25, rib 26 defines an annular seat 34 which, with the interposition of a bearing coaxial with axis 24, houses in rotary manner the inner periphery of a respective face cam 35, the active surface 36 of which faces the active surface 36 of the other face cam 35, and comprises, as shown more clearly in FIG. 3, a groove 37 coiling by an angle of at least 720°, and preferably of about 750°, about axis 24.

Face cams 35 form part of pressure device 22, and control the axial position of rods 28 with respect to drum 23, and therefore the diameter of circular passage 31. For which purpose, as shown more clearly in FIG. 2, each rod 28 is fitted, on the end outside rib 26 and opposite the end supporting relative pressure roller 29, with a cross member 38 perpendicular to active surfaces 36 and supporting, at each end, a cam follower roller 39 which rolls transversely along groove 37 of relative face cam 35.

A variation, not shown, has only one cam, and each rod 28 has one cam follower.

As shown in FIG. 3, being arranged along a roughly 360° arc about axis 24, and having to define, with respective pressure rollers 29, circular passage 31 coaxial with axis 24, rods 28 are of different lengths; and the length of each rod 28 differs from that of any one of the other rods 28 by an amount equal to the difference in the radius of grooves 37 between the two rods 28 considered.

As shown in FIG. 3, the rod 28 whose pressure roller 29 would be located, in use, at longitudinal join line 4 of shaft 2 is missing.

As shown in FIG. 2, face cams 35 are rotated about axis 24 by an actuator assembly 40 fitted to carriage 11, and which comprises two ring gears 41, each of which is integral with relative face cam 35, is coaxial with axis 24, and is connected in rotary manner to the outer periphery of relative annular flange 25; a drive shaft 42, which is parallel to axis 24, is supported for rotation by two brackets projecting downwards from lower cross members 16, and is fitted with two pinions 43, each meshing with respective ring gear 41; and a reversible motor reducer 44, which is controlled by a central control unit not shown, is supported by one of lower cross members 16, and powers drive shaft 42.

In actual use, device 1 can be operated in two modes.

In a first mode, to which the accompanying drawings refer, shaft 2 is fed to device 1, by a feed device not shown, with axis 3 parallel to feed direction 10, and so that one end of the shaft engages circular passage 31 defined by pressure rollers 29. As shown in FIG. 2, shaft 2 is positioned with its longitudinal join line 4 facing upwards and beneath two electrowelding electrodes 45 located immediately upstream from circular passage 31 and between passage 31 and a spacer 46, which is inserted between the edges of longitudinal join line 4 to keep the edges a given distance apart.

Before inserting the end of shaft 2 through circular passage 31 to reach the initial position shown in FIG. 2, actuator assembly 40 is operated to rotate face cams 35 (anticlockwise in FIG. 3) to the maximum diameter of circular passage 31; electrodes 45 are raised; and actuator assembly 13 is operated to lock axis 24 at a given level. Said feed device (not shown), which a known type, also comprises level adjusting devices, which are operated to position axis 3 of shaft 2 coaxial with axis 24. Alternatively, shaft 2 is made coaxial with axis 24 by moving carriage 11.

Face cams 35 are rotated (clockwise in FIG. 3) to bring pressure rollers 29 into contact with, and to press on, the outer surface of shaft 2, so as to press the edges of longitudinal join line 4 against one another with a given pressure; and electrodes 45 are lowered substantially into contact with the outer surface of shaft 2.

At this point, carriage 11—which is not needed in the first operating mode—is locked in position; electrodes 45 are activated to heat the edges of longitudinal join line 4 to close to melting temperature; shaft 2 is pulled in direction 10 through circular passage 31 at a given travelling speed, normally by means of a traction device (not shown) connected to the leading end of shaft 2; and actuator assembly 40 is synchronized with the traction device (not shown) to adapt, instant by instant, the diameter of passage 31 to the diameter of the section of shaft 2 travelling through plane P, to press the edges of longitudinal join line 4 against each other and weld the edges to each other.

Since longitudinal join line 4 slopes with respect to direction 10 as shaft 2 is fed in direction 10 parallel to axis 24, the level of electrodes 45 is adjusted gradually to adapt to the varying level of the portion of longitudinal join line 4 beneath electrodes 45 (in the example shown, in which shaft 2 is advanced narrow-end first, the join line slopes upwards, though shaft 2 may equally well be advanced wide-end first).

In the second operating mode, shaft 2 is fed to device 1 with longitudinal join line 4 parallel to direction 10.

Electrodes 45 may therefore be maintained at a fixed level. In this case, however, since it is axis 3 that slopes with respect to direction 10, and the point of intersection of axis 3 with plane P moves (downwards, in the example shown) as shaft 2 travels through passage 31, but must always coincide with the centre of passage 31, actuator assembly 13 is also synchronized with the traction device (not shown) to shift carriage 11 gradually and keep the centre of passage 31 along axis 3 at all times.

As will be clear from the foregoing description, pressure rollers 29 being activated, not by respective actuating devices, but by a single pressure device 22 acting simultaneously'from the outside on rods 28 of all the pressure rollers 29, pressure rollers 29 can be spaced close enough apart to define, for the section of shaft 2 currently be fed through passage 31, a substantially continuous retaining surface preventing deformation of shaft 2 in the area close to longitudinal join line 4, as normally occurs when using hydraulically controlled pressure rollers.

1) A device for final calibration of tapered tubular shafts (2), the device comprising an annular support (23) having an axis (24); a number of pressure rollers (29) arranged about the axis (24), each pressure roller (29) being supported by the annular support (23) to move, with respect to the annular support (23), in a respective radial direction with respect to the axis (24) to define, together with the other pressure rollers (29), a passage (31) for calibrating a tapered shaft (2) fed, in use, through the passage (31) in a given feed direction (10) parallel to the axis (24); and a pressure device (22) for moving the pressure rollers (29) in the respective radial directions to vary the size of the passage (31); and being characterized in that the pressure device (22) is a cam device (35) common to all the pressure rollers (29).

2) A device as claimed in claim 1, and comprising at least one cam follower (39) for each pressure roller (29); the pressure device (22) comprising at least one cam (35) connected to the cam followers (39) of all the pressure rollers (29).

3) A device as claimed in claim 1, wherein the pressure device (22) is a cam device rotating about the axis (24).

4) A device as claimed in claim 1, and comprising, for each pressure roller (29), a rod (28) supporting for rotation the relative pressure roller (29) and extending in axially sliding and angularly fixed manner through the annular support (23) in a respective radial direction with respect to the axis (24); the pressure device (22) acting simultaneously on the rods (28) of all the pressure rollers (29).

5) A device as claimed in claim 4, wherein the pressure device (22) comprises at least one face cam (35) rotating about the axis (24) and having an active surface (36) facing the rods (28) and having a spiral groove (37); each rod (28) having a cam follower (39) engaging the groove (37) in sliding manner.

6) A device as claimed in claim 4, wherein the pressure device (22) comprises two face cams (35) rotating about the axis (24) and located on opposite sides with respect to the rods (28); each face cam (35) has an active surface (36) facing the rods (28) and having a spiral groove (37); and each rod (28) has, for each face cam (35), a respective cam follower (39) engaging the groove (37) in the face cam (35) in sliding manner.

7) A device as claimed in claim 5, wherein the rods (28) are of different lengths; the length of each rod (28) differing from the length of any other rod (28) by an amount equal to the variation in the radius of the spiral grooves (37) between the two rods (28) considered.

8) A device as claimed in claim 5, wherein the spiral groove (37) extends by an angle of at least 720° about the axis (24).

9) A device as claimed in claim 4, and comprising first actuating means (40) connected to the, or to each, face cam (35) to rotate the face cam (35) about the axis (24) synchronously with travel of the tapered shaft (2) through the passage (31).

10) A device as claimed in claim 1, and comprising a fixed frame (5), and a carriage (11) fitted to the frame (5) to move in a given travel direction (12) with respect to the frame (5); the annular support (23) being integral with the carriage (11), and the travel direction (12) being perpendicular to the axis (24) and to the feed direction (10).

11) A device as claimed in claim 10, and comprising second actuating means (13), which are interposed between the frame (5) and the carriage (11) to move the carriage (11) in the travel direction (12) with respect to the frame (5), and are synchronizable with travel of the tapered shaft (2) through the passage (31).
